(19) United States
(12) Patent Application Publication
(10) Pub. No.: US 2025/0010637 A1
(43) Pub. Date: Jan. 9, 2025

(54) INK-JET RECORDING APPARATUS

(71) Applicant: CANON KABUSHIKI KAISHA, Tokyo (JP)

(72) Inventor: SHINICHI ISOZAKI, Saitama (JP)

(21) Appl. No.: 18/762,121

(22) Filed: Jul. 2, 2024

(30) Foreign Application Priority Data
Jul. 5, 2023 (JP) 2023-111070

(51) Int. Cl. B41J 11/00; B41J 13/08

(52) U.S. Cl. CPC B41J 11/00216; B41J 11/00212; B41J 11/00218; B41J 13/08

(57) ABSTRACT

An ink-jet recording apparatus includes a first belt, a heating unit, a second belt, a pressing member, and a temperature detection member. The first belt heats a sheet. The heating unit is disposed inside the first belt and heats the first belt in a non-contact manner. The second belt comes into contact with the first belt to form a nip portion together with the first belt, and fixes an ink image on the sheet to the sheet in the nip portion. The pressing member comes into contact with an inner circumferential surface of the second belt in the nip portion, presses the first belt via the second belt, and includes an opening formed in a heated region to be heated by the heating unit. The temperature detection member is disposed in the opening and detects a temperature of the inner circumferential surface of the second belt.

### BACKGROUND

### Field

The present disclosure relates to a fixing device that fixes an image formed with ink to a sheet, and an ink-jet recording apparatus.

### Description of the Related Art

Conventionally known is an ink-jet recording apparatus that ejects ink to a sheet and forms an image on the sheet. In the ink-jet recording apparatus, used is a heating device that applies heat and pressure to the sheet on which the image is formed with ink to permeate ink in the sheet and increase fixability of ink. As an example of such a heating device, known is a heating device of a heat fixing system including a fixing roller that is heated by a heating member including a heater, and a pressure roller that is in pressure contact with the fixing roller and that forms a fixing nip portion. The heating device of the heat fixing system applies pressure and heat to the sheet while the sheet is nipped and conveyed by the fixing nip portion.

In a case of an electrophotographic image forming apparatus, temperature control has been conventionally performed based on a detection result from a thermistor that detects a temperature of the fixing roller. According to Japanese Patent Application Laid-Open No. 2006-53310, control is performed to stop power supply to a heater when a temperature of the heater becomes a predetermined temperature or higher based on a detection result from a thermistor that detects the temperature of the heater.

### SUMMARY

According to an aspect of the present disclosure, an ink-jet recording apparatus includes a first belt configured to heat a sheet, a heating unit disposed inside the first belt and configured to heat the first belt in a non-contact manner, a second belt configured to come into contact with the first belt to form a nip portion together with the first belt, and configured to fix an ink image on the sheet to the sheet in the nip portion, a pressing member configured to come into contact with an inner circumferential surface of the second belt in the nip portion, configured to press the first belt via the second belt, and including an opening formed in a heated region to be heated by the heating unit, and a temperature detection member disposed in the opening and configured to detect a temperature of the inner circumferential surface of the second belt.

Further features of the present disclosure will become apparent from the following description of exemplary embodiments with reference to the attached drawings.

### BRIEF DESCRIPTION OF THE DRAWINGS

FIG. 1 is a cross-sectional view schematically illustrating an overall configuration of an ink-jet recording apparatus according to a first exemplary embodiment.

FIG. 2 is a cross-sectional view schematically illustrating a fixing device according to the present exemplary embodiment.

FIG. 3 is a cross-sectional view schematically illustrating a temperature detection member and a second belt according to the present exemplary embodiment.

FIG. 4 is a view illustrating the temperature detection member according to the present exemplary embodiment.

FIGS. 5A and 5B are block diagrams according to present exemplary embodiment.

FIGS. 6A and 6B are flowcharts according to the present exemplary embodiment.

FIG. 7 is a cross-sectional view schematically illustrating a temperature detection member and the second belt according to a second exemplary embodiment.

FIGS. 8A and 8B are block diagrams according to a third exemplary embodiment.

FIGS. 9A and 9B are flowcharts according to the third exemplary embodiment.

FIGS. 10A and 10B are flowcharts of abnormality detection circuits according to the third exemplary embodiment.

### DESCRIPTION OF THE EMBODIMENTS

### <Image Forming Apparatus>

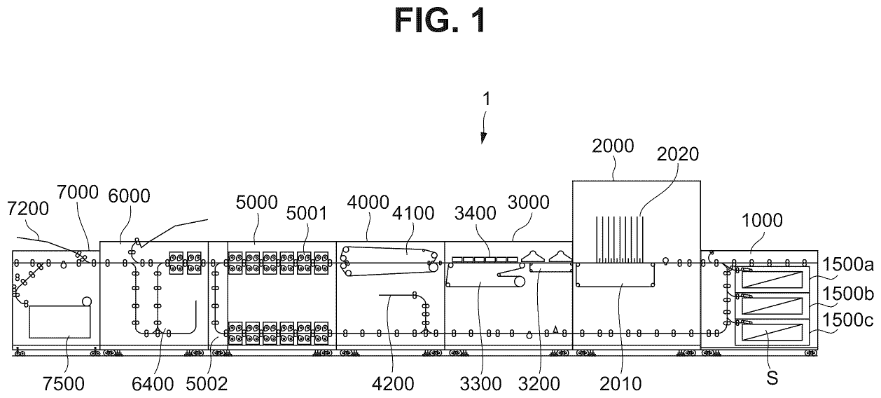

Exemplary embodiments of the present disclosure will be described in detail below with reference to the drawings. FIG. 1 is a schematic view illustrating an ink-jet recording apparatus according to a first exemplary embodiment. An ink-jet recording apparatus 1 is a so-called sheet-fed ink-jet recording apparatus that forms ink on a sheet using two kinds of liquid, which are reaction liquid and ink. The sheet is only required to be a recording material that is capable of accepting ink, including paper such as plain paper and thick paper, a plastic film such as an overhead projector sheet, a sheet having a special shape such as an envelope and an index sheet, and a cloth.

As illustrated in FIG. 1, the ink-jet recording apparatus 1 according to the present exemplary embodiment includes a paper feeding module 1000, a print module 2000, a drying module 3000, a fixing module 4000, a cooling module 5000, a reversing module 6000, and a stacking module 7000.

A sheet S fed from the paper feeding module 1000 is subjected to various kinds of processing when being conveyed along a conveyance route within each module, and eventually discharged onto the stacking module 7000.

The paper feeding module 1000, the print module 2000, the drying module 3000, the fixing module 4000, the cooling module 5000, the reversing module 6000, and the stacking module 7000 may have individual housings. These housings may be coupled to each other to constitute the ink-jet recording apparatus 1. Alternatively, the paper feeding module 1000, the print module 2000, the drying module 3000, the fixing module 4000, the cooling module 5000, the reversing module 6000, and the stacking module 7000 may be disposed in one housing.

The paper feeding module 1000 includes containers 1500a to 1500c that contain the sheet S. The containers 1500a to 1500c are provided so that they can be pulled toward the front side of the ink-jet recording apparatus 1 to contain the sheet S. Sheets S are fed one sheet by one sheet from each of the containers 1500a to 1500c by a separation belt and conveyance rollers, and are conveyed to the print module 2000. The number of containers is not limited to three, and one, two, or four or more containers may be included.

The print module 2000 as an image forming unit includes a pre-image formation registration correction unit (not illustrated), a print belt unit 2010, and a recording unit 2020. The sheet S fed from the paper feeding module 1000 is subjected to correction of an inclination and correction of a position by the pre-image formation registration correction unit, and conveyed to the print belt unit 2010. The recording unit 2020 is disposed at a position facing the print belt unit 2010 across the conveyance route. The recording unit 2020 ejects ink onto the conveyed sheet S from above with a recording head to form an image. A plurality of recording heads that ejects ink is arranged along a conveyance direction. In the present exemplary embodiment, a total of five linear recording heads corresponding to reaction liquid in addition to four colors of yellow (Y), magenta (M), cyan (C), and black (Bk). The sheet S is conveyed by being sucked by the print belt unit 2010, whereby a clearance from each recording head is ensured.

The number of colors of ink and the number of recording heads are not limited to five, which has been described above. As an ink-jet system, a system using a heating element, a system using a piezoelectric element, a system using an electrostatic element, a system using a micro-electro-mechanical system (MEMS) element, or the like can be adopted. Ink in each color is supplied to a corresponding recording head via a corresponding ink tube from a corresponding ink reservoir, which is not illustrated. Ink contains a resin component at a content rate of “0.1 to 20.0 percent by mass”, water, a water-soluble organic solvent, a coloring material, wax, an additive, and the like.

The sheet S on which an image is formed by the recording unit 2020 is subjected to detection of a shift and color density of the image formed on the sheet S by an in-line scanner (not illustrated) when being conveyed by the print belt unit 2010. Based on the shift and color density of the image, correction on the image formed on the sheet S, the density, or the like is performed.

The drying module 3000 includes a decoupling unit 3200, a drying belt unit 3300, and a warm air blowing unit 3400. The drying module 3000 decreases an amount of liquid of ink and reaction liquid applied to the sheet S to increase the fixability of ink to the sheet S in the subsequent fixing module 4000. The sheet S on which the image has been formed is conveyed to the decoupling unit 3200 disposed in the drying module 3000. The decoupling unit 3200 generates friction force between the sheet S and a belt with air pressure of the air blown from the above, and thereby conveys the sheet S with the belt. With this configuration, the sheet S placed on the belt is conveyed by friction force, whereby the shift of the sheet S is prevented when the sheet S is conveyed from the print belt unit 2010 to the decoupling unit 3200. The sheet S conveyed from the decoupling unit 3200 is conveyed by being sucked in the drying belt unit 3300, hot air is blown from the warm air blowing unit 3400 disposed above the belt, whereby each of the ink and the reaction liquid applied to the sheet S is dried.

Accordingly, the drying module 3000 heats the ink and the reaction liquid applied to the sheet S and facilitates evaporation of moisture, which enables prevention of so-called cockling in which ink scatters over the sheet S and a line like a rim is generated in the periphery. As the drying module 3000, any device that can perform heating and drying may be used, and, for example, a blow-dryer and a heater are preferable. As for the heater, for example, heating by an electrically heated wire and an infrared heater is preferable in terms of safety and energy efficiency.

The fixing module 4000 includes a fixing belt unit 4100. The fixing belt unit 4100 causes the sheet S conveyed from the drying module 3000 to pass between a heated upper belt unit and a heated lower belt unit, and thereby fixes an ink image to the sheet S. Details of the fixing belt unit 4100 will be described below.

The cooling module 5000 includes a plurality of cooling units 5100, which cools the hot sheet S conveyed from the fixing module 4000. The cooling unit 5100, for example, takes in outside air into a cooling box with a fan to increase pressure inside the cooling box, and blows wind, which blows out from the cooling box with pressure via a nozzle, to the sheet S to cool the sheet S. The cooling units 5100 are disposed on respective sides of the conveyance route of the sheet S and cool both sides of the sheet S.

The cooling module 5000 is provided with a conveyance route switching unit 5002. The conveyance route switching unit 5002 switches the conveyance route of the sheet S depending on a case of conveyance of the sheet S to the reversing module 6000 and a case of conveyance of the sheet S to a double-sided printing conveyance route for double-sided printing to form images on both sides of the sheet S.

The reversing module 6000 includes a reversing unit 6400. The reversing unit 6400 reverses the front side and back side of the conveyed sheet S, and changes the orientation of the front side and back side of the sheet S when the sheet S is discharged to the stacking module 7000. The stacking module 7000 includes a top tray 7200 and a loading unit 7500, on each of which the sheet S conveyed from the reversing module 6000 is stacked.

At the time of double-sided printing, the sheet S is conveyed from the conveyance route switching unit 5002 to the conveyance route below the cooling module 5000. Thereafter, the sheet S passes through the double-sided printing conveyance route in the fixing module 4000, the drying module 3000, the print module 2000, and the paper feeding module 1000, and returns to the print module 2000. The double-sided conveying section of the fixing module 4000 is provided with a reversing unit 4200 that reverses the front side and back side of the sheet S. On the sheet S that has returned to the print module 2000, an image is also formed with ink on the other side on which an image has yet to be formed. Thereafter, the sheet S passes through the drying module 3000, the fixing module 4000, the cooling module 5000, and the reversing module 6000, and is discharged to the stacking module 7000.

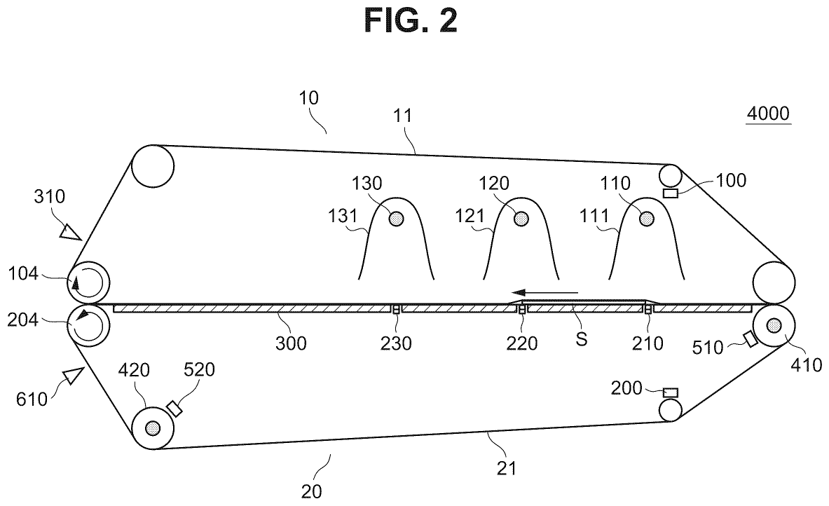

An overview of the fixing module 4000 in the present exemplary embodiment is to be described with reference to FIG. 2.

As illustrated in FIG. 2, the fixing module 4000 includes an upper belt unit (upper fixing belt system) 10 and a lower belt unit (lower fixing belt system) 20. The sheet S is nipped and conveyed by the upper belt unit 10 and the lower belt unit 20, during which each of pressure and heat is applied to the sheet S, whereby an ink image formed with ink is fixed to the sheet S.

FIG. 2 is a view illustrating an overall configuration including the upper fixing belt system 10 and lower fixing belt system 20 of the fixing system in the image forming apparatus of an ink-jet recording system according to the first exemplary embodiment.

In the ink-jet recording system, a sheet to which ink is applied is dried to evaporate moisture, and thereafter each of heat and pressure is applied to the sheet to fix an image. The upper fixing belt system 10 and the lower fixing belt system 20 are the fixing system that causes the dried sheet S to pass through a nip portion between a heated first belt 11 and a heated second belt 21 to permeate the applied ink image on the sheet S and fix the ink image to the sheet S. The nip portion between the upper and lower belts being long facilitates permeation of ink into the sheet S and increases resistance to chafing. Furthermore, elongating a nip distance between the upper and lower belts can achieve high productivity. The rotation of driving rollers 104 and 204 by respective driving motors (not illustrated) rotates the first belt 11 and the second belt 21, respectively, whereby the sheet S is conveyed in a direction of arrow. The image forming apparatus according to the present exemplary embodiment has a configuration in which ink is applied to a top surface (first belt 11 side) of the sheet S, and on-demand heaters 110, 120, and 130 configured to dissolve a solvent component included in ink are arranged on the first belt 11 side. The configuration also includes lower belt heaters 410 and 420 to supplementarily heat the sheet S to which ink is applied.

The on-demand heaters 110, 120, and 130 are provided inside the first belt 11. Furthermore, the on-demand heaters 110, 120, and 130 are provided not in contact with the first belt 11. Providing the on-demand heaters 110, 120, and 130 not in contact with the first belt 11 eliminates an obstacle to the first belt 11 as a target of heating and can thereby heat the first belt 11 with high heat responsiveness.

A plurality of on-demand heaters is arranged along the sheet conveyance direction as illustrated in FIG. 2.

The three on-demand heaters are provided in the present exemplary embodiment, but the configuration is not limited to the example, and is only required to include a plurality of on-demand heaters. In a case of the configuration including the plurality of on-demand heaters in this manner, the nip portion increases in the sheet conveyance direction.

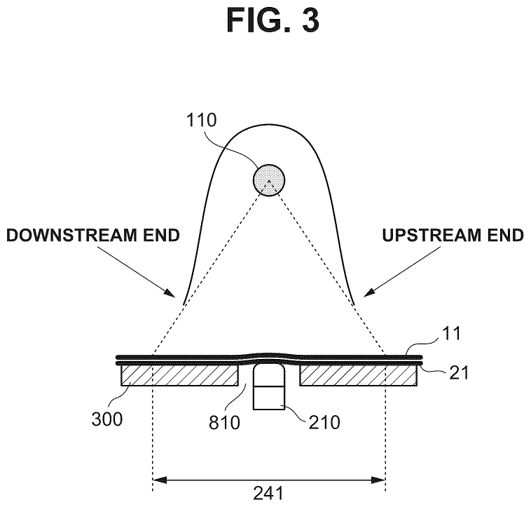

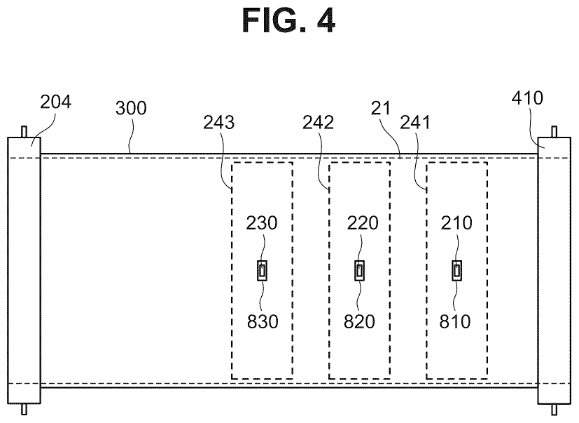

The upper fixing belt system 10 is composed of the first belt 11, the driving roller 104, the on-demand heaters 110, 120, and 130, temperature detection members 210, 220, and 230, a temperature sensor for temperature adjustment 310, and a rotation detection sensor 100. The on-demand heaters 110, 120, and 130 are respectively covered with reflectors 111, 121, and 131, and heat the first belt 11 immediately below the on-demand heaters 110, 120, and 130. The reflectors 111, 121, and 131 condense infrared light emitted from the on-demand heaters 110, 120, and 130 into the first belt 11. The temperature sensor for temperature adjustment 310 detects a temperature of the first belt 11. The rotation detection sensor 100 is disposed on a belt follower roller, and is a sensor that detects whether the first belt 11 is rotating. When the rotation of the first belt 11 stops, the rotation detection sensor 100 detects the stop, and power supply to the on-demand heaters 110, 120, and 130 is cut off. A pressing member 300 is a member that supports a long nip portion between the first belt 11 and the second belt 21 from the lower side of the second belt 21. Thermo switches 210, 220, and 230, as temperature detection members, monitor abnormality of a temperature of the second belt 21 from respective openings arranged in the pressing member 300 at respective positions in an infrared radiation range immediately below the on-demand heaters 110, 120, and 130. In a case where the temperature exceeds a predetermined threshold, the thermo switches 210, 220, and 230 cut off power supply to the on-demand heaters 110, 120, and 130. Installation positions of the thermo switches 210, 220, and 230 will be described in detail with reference to FIGS. 2 and 3. A method of cutting off power supply to each of the on-demand heaters 110, 120, and 130 at the time of detection of abnormality will be described in detail with reference to FIG. 4.

The lower fixing belt system 20 is composed of the second belt 21, the driving roller 204, the lower belt heaters 410 and 420, thermo switches 510 and 520, a temperature sensor for temperature adjustment 610, and a rotation detection sensor 200. The second belt 21 comes into contact with an outer circumferential surface of the first belt 11 to form the nip portion. The lower belt heaters 410 and 420 are heating roller components each including a heating element inside a hollow roller, and heat the second belt 21 via the respective rollers. The thermo switches 510 and 520 detect abnormal heating of the lower belt heaters 410 and 420, respectively, and cut off power supply to the lower belt heaters 410 and 420. The temperature sensor for temperature adjustment 610 detects a temperature of the second belt 21. The rotation detection sensor 200 is disposed on a follower roller, and detects whether the second belt 21 is rotating. When the rotation of the second belt 21 stops, the rotation detection sensor 200 detects the stop, and cuts off power supply to the lower belt heaters 410 and 420. A method of cutting off power supply to each of the lower belt heaters 410 and 420 at the time of detection of abnormality will be described in detail with reference to FIG. 4.

FIG. 3 is an example of a view illustrating a heating portion of each of the three on-demand heaters 110, 120, and 130 when viewed from the side. The description is given using the on-demand heater 110 as a representative example. The heating portion of the on-demand heater 120 and the thermo switch 220 have a similar positional relationship, and the heating portion of the on-demand heater 130 and the thermo switch 230 have a similar positional relationship.

The on-demand heaters 110, 120, and 130 heat the first belt 11 in a range of a heated region 241, and heat is also transmitted to the second belt 21 that is forming the nip portion. The pressing member 300 is in contact with the inner circumferential surface of the second belt 21. The pressing member 300 supports the lower surface of the first belt 11 and that of the second belt 21 from the inner circumferential surface of the second belt 21. The pressing member 300 is provided with an opening 810 in the heated region 241. The thermo switch 210 is a contact-type temperature detection member. That is, the thermo switch 210 partially protrudes from the opening 810. As a result, the thermo switch 210 and the second belt 21 come into contact with each other. With this configuration, the thermo switch 210 detects a temperature of the surface of the second belt 21 in contact with the pressing member 300, and thereby monitors abnormal heating of the first belt 11 and the second belt 21 by the on-demand heater 110.

The reason for providing the opening 810 in the pressing member 300 to monitor abnormal heating of the first belt 11 and the second belt 21 from the lower side is as follows. States of the first belt 11 and the second belt 21 heated by the on-demand heater 110 are desired to be monitored by the thermo switch 210 via the pressing member 300. However, the pressing member 300 is made of thick metal or the like and has a relatively large heat capacity. For this reason, an increase in temperature of the pressing member 300 becomes slower than an increase in temperature of the first belt 11 and the second belt 21. As a result, it is not possible to detect a temperature of the first belt 11 and the second belt 21 with high responsivity. To address this issue, the opening 810 is provided so that the thermo switch 210 monitors the temperature of the first belt 11 and the second belt 21 without the intervention of the pressing member 300.

A temperature detection surface of the thermo switch 210 slightly protrudes toward the second belt 21 from a contact surface between the pressing member 300 and the second belt 21, and is installed so as to surely come into contact with the second belt 21. This increases heat conductivity, and enables detection of the temperature of the first belt 11 and the second belt 21 with high responsivity.

Furthermore, in the sheet conveyance direction, a configuration in which the temperature detection member 210 (thermo switch 210) is disposed between an upstream end of the reflector 111 and a downstream end of the reflector 111 may be adopted. With this configuration, the temperature detection member 210 can be disposed in a range in which a temperature becomes higher, and is capable of detecting the temperature of the second belt 21 with higher accuracy.

FIG. 4 is a view illustrating the nip portion between the first belt 11 and the second belt 21 in which the sheet S is nipped, conveyed, and heated when viewed from the lower surface of the pressing member 300 in the first exemplary embodiment. Openings 810, 820, and 830 are respectively provided within ranges of heated regions 241, 242, and 243 of the pressing member 300. The heated regions 241, 242, 243 are respectively heated by the on-demand heaters 110, 120, and 130. The thermo switches 210, 220, and 230 are respectively installed in the openings 810, 820, and 830 so as to detect the temperature of the surface of the second belt 21 in contact with the pressing member 300.

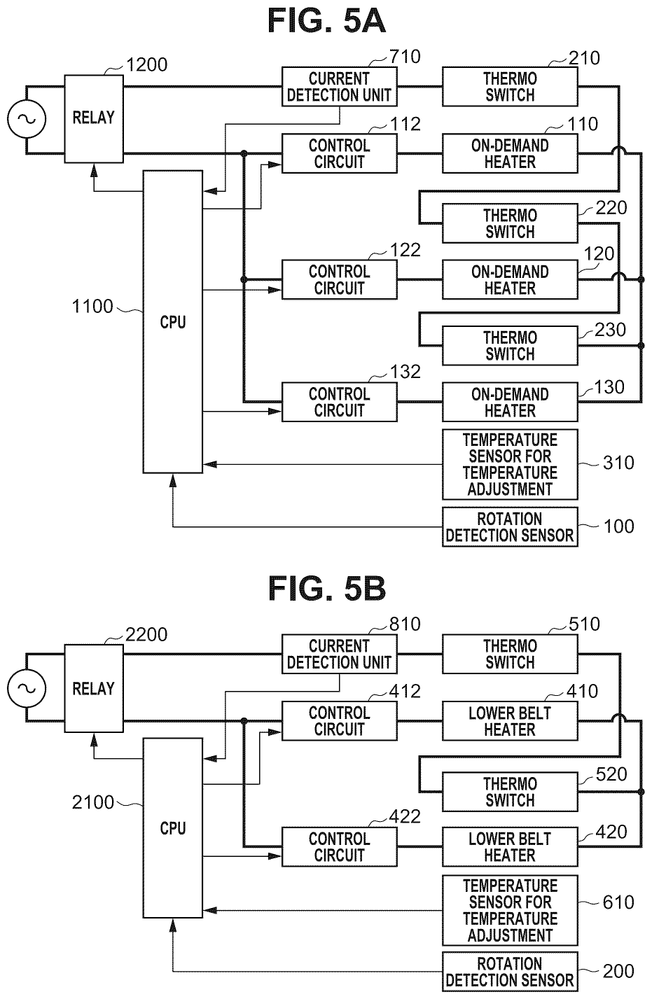

FIGS. 5A and 5B are control block diagrams each illustrating the fixing system according to the first exemplary embodiment. FIG. 5A is a control block diagram of the upper fixing belt system 10. The upper fixing belt system 10 is composed of a central processing unit (CPU) 1100, a relay 1200, control circuits 112, 122, and 132, the on-demand heaters 110, 120, and 130, the temperature sensor for temperature adjustment 310, the thermo switches 210, 220, and 230, and the rotation detection sensor 100.

The CPU 1100 controls the control circuits 112, 122, and 132 based on temperature information from the temperature sensor for temperature adjustment 310 to adjust power supplied to the on-demand heaters 110, 120, and 130 and thereby adjust a temperature. The thermo switches 210, 220, and 230 are connected in series with a line that supplies power to the on-demand heaters 110, 120, and 130 and are in a conductive state at normal times. However, the thermo switches 210, 220, and 230 are shifted to a cut-off state when detecting a temperature exceeding a threshold due to abnormal heating by the on-demand heaters 110, 120, and 130. That is, power supply to the on-demand heaters 110, 120, and 130 is forcibly cut off. A current detection unit 710 is connected in series with the line that supplies power to the on-demand heaters 110, 120, and 130, and transmits a result of detection of supplied current to the CPU 1100. The relay 1200 is connected in series with the line that supplies power to the on-demand heaters 110, 120, and 130. The relay 1200 performs power supply in an ON-state and stops power supply in an OFF-state. ON/OFF control is performed by the CPU 1100. The rotation detection sensor 100 monitors a rotation state of the first belt 11. In a case of detecting a stop, the rotation detection sensor 100 outputs a signal indicating a stop state to the CPU 1100. The CPU 1100, which has received the signal, turns OFF the relay 1200.

FIG. 5B is a control block diagram of the lower fixing belt system 20. The lower fixing belt system 20 is composed of a CPU 2100, a relay 2200, control circuits 412 and 422, lower belt heaters 410 and 420, a temperature sensor for temperature adjustment 610, thermo switches 510 and 520, and the rotation detection sensor 200.

The CPU 2100 controls the control circuits 412 and 422 based on temperature information from the temperature sensor for temperature adjustment 610 to adjust power supplied to the lower belt heaters 410 and 420, and thereby adjust a temperature.

The thermo switches 510 and 520 are connected in series with a line that supplies power to the lower belt heaters 410 and 420 and are in a conductive state at normal times. However, the thermo switches 510 and 520 are shifted to a cut-off state when detecting a temperature exceeding a threshold due to abnormal heating by the lower belt heaters 410 and 420. That is, power supply to the lower belt heaters 410 and 420 is forcibly cut off. The current detection unit 710 is connected in series with the line that supplies power to the lower belt heaters 410 and 420, and transmits a result of detection of supplied current to the CPU 2100. The relay 2200 is connected in series with the line that supplies power to the lower belt heaters 410 and 420. The relay 2200 performs power supply in an ON-state and stops power supply in an OFF-state. ON/OFF control is performed by the CPU 2100. The rotation detection sensor 200 monitors a rotation state of the second belt 21. In a case of detecting a stop, the rotation detection sensor 200 outputs a signal indicating a stop state to the CPU 2100. The CPU 2100, which has received the signal, turns OFF the relay 2200.

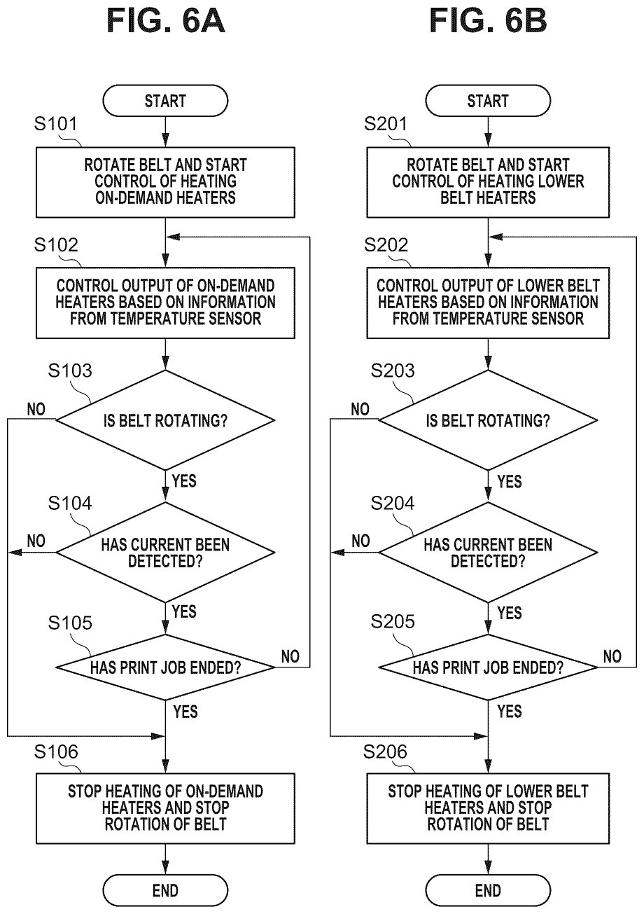

FIGS. 6A and 6B are flowcharts each describing control of the fixing system according to the first exemplary embodiment. FIG. 6A is a flowchart describing control of the upper fixing belt system 10.

When control of the upper fixing belt system 10 is started, the processing proceeds to step S101.

In step S101, the CPU 1100 controls the driving roller 104 for the first belt 11 to rotate the first belt 11, and starts control of heating the on-demand heaters 110, 120, and 130. The processing then proceeds to step S102.

In step S102, the CPU 1100 adjusts output of the on-demand heaters 110, 120, and 130 based on temperature information from the temperature sensor for temperature adjustment 310 and adjusts a temperature of the first belt 11.

The temperature of the first belt 11 is adjusted to be a constant temperature to maintain quality of a printing medium. The processing proceeds to step S103.

In step S103, the CPU 1100 determines whether the first belt 11 is rotating based on a value from the rotation detection sensor 100. In a case where the CPU 1100 determines that the first belt 11 is rotating based on the value from the rotation detection sensor 100 (YES in step S103), the processing proceeds to step S104. In a case where the CPU 1100 determines that the first belt 11 is not rotating based on a signal from the rotation detection sensor 100 (NO in step S103), the processing proceeds to step S106.

In step S104, the CPU 1100 determines whether current flows through the on-demand heaters 110, 120, and 130 based on a value from the current detection unit 710. In a case where the CPU 1100 determines that current flows through the on-demand heaters 110, 120, and 130 (YES in step S104), the processing proceeds to step S105.

In a case of determining that no current flows through the on-demand heaters 110, 120, and 130 (NO in step S104), the CPU 1100 determines that it is an abnormal state, and the processing proceeds to step S106.

In step S105, the CPU 1100 determines whether it is notified of the end of a print job by a print job controller, which is not illustrated. In a case where the CPU 1100 is notified of the end of the print job (YES in step S105), the processing proceeds to step S106. In a case where the CPU 1100 is not notified of the end of the print job (NO in step S105), the processing proceeds to step S102.

In step S106, the CPU 1100 stops control of heating the on-demand heaters 110, 120, and 130 to stop the rotation of the first belt 11, and ends the control.

FIG. 6B is a flowchart describing control of the lower fixing belt system 20.

When control of the lower fixing belt system 20 is started, the processing proceeds to step S201.

In step S201, the CPU 2100 controls the driving roller 204 for the second belt 21 to rotate the second belt 21, and starts control of heating the lower belt heaters 410 and 420. The processing then proceeds to step S202.

In step S202, the CPU 2100 adjusts output of the lower belt heaters 410 and 420 based on temperature information from the temperature sensor for temperature adjustment 610 to adjust the temperature of the second belt 21. The temperature of the second belt 21 is controlled to be a constant temperature to maintain quality of a printing medium. The processing proceeds to step S203.

In step S203, the CPU 2100 determines whether the second belt 21 is rotating based on a value from the rotation detection sensor 200. In a case where the CPU 2100 determines that the second belt 21 is rotating based on the value from the rotation detection sensor 200 (YES in step S203), the processing proceeds to step S204. In a case where the CPU 2100 determines that the second belt 21 is not rotating based on a signal from the rotation detection sensor 200 (NO in step S203), the processing proceeds to step S206.

In step S204, the CPU 2100 determines whether current flows through the lower belt heaters 410 and 420 based on a value from the current detection unit 710. In a case where the CPU 2100 determines that current flows through the lower belt heaters 410 and 420 (YES in step S204), the processing proceeds to step S205. In a case of determining that no current flows through the lower belt heaters 410 and 420 (NO in step S204), the CPU 2100 determines that it is an abnormal state where any of the thermo switches 510 and 520 is cut off, and the processing proceeds to step S206.

In step S205, the CPU 2100 determines whether it is notified of the end of the print job by the print job controller, which is not illustrated. In a case where the CPU 2100 is notified of the end of the print job (YES in step S205), the processing proceeds to step S206. In a case where the CPU 2100 is not notified of the end of the print job (NO in step S205), the processing proceeds to step S202.

In step S206, the CPU 2100 stops control of heating the lower belt heaters 410 and 420 to stop the rotation of the second belt 21, and ends the control.

The thermo switches 210, 220, 230, 510, and 520 operate regardless of the flow of control in FIGS. 6A and 6B described above.

The above-mentioned configuration enables detection with high responsivity in the on-demand fixing system.

A curving process may be performed on one side of the opening 810 sliding with the second belt 21. By forming the opening 810, there occurs so-called edge butting due to sliding of the edge of the opening 810 and the second belt 21. To suppress this edge butting, the curving process may be performed on a portion of the pressing member 300 in which the opening 810 is formed. The curving process is only required to be performed on a downstream side of the conveyance direction of the second belt 21.

Because the pressing member 300 is made of metal and slides with the second belt 21, a configuration may be adopted in which the surface of the pressing member 300 is embossed to increase slidability.

A second exemplary embodiment is now to be described. An overall configuration, a block diagram, and a flowchart are similar to those according to the first exemplary embodiment.

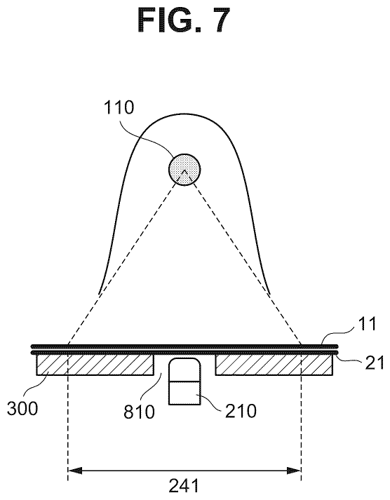

FIG. 7 is a view illustrating a heating portion of each of the three on-demand heaters when viewed from the side according to the second exemplary embodiment. The description is given of a difference from the first exemplary embodiment using the on-demand heater 110 as a representative example.

The heating portion of the on-demand heater 120 and the thermo switch 220 have a similar positional relationship, and the heating portion of the on-demand heater 130 and the thermo switch 230 have a similar positional relationship.

The temperature detection surface of the thermo switch 210 is caused to slightly recess downward from the contact surface between the pressing member 300 and the second belt 21, and is installed at a certain distance from the second belt 21. This enables detection of a temperature of the second belt 21 without raising concerns about abrasion on both of the second belt 21 and the thermo switch 210 due to friction between the second belt 21 and the thermo switch 210.

The thermo switch 210 may be an infrared sensor using infrared radiation, and may be disposed so that the infrared sensor and the pressing member 300 do not overlap with each other in an axis line direction that is parallel with the conveyance direction. That is, a configuration may be adopted in which the infrared sensor indirectly detects a temperature of the second belt 21 exposed in a groove portion of the pressing member 300.

A third exemplary embodiment is directed to a fixing system in a case where the thermo switches 210, 220, and 230 used in the first exemplary embodiment are replaced with abnormality detection temperature sensors 211, 221, and 231, and the thermo switches 510 and 520 used in the first exemplary embodiment are replaced with abnormality detection temperature sensor 511 and 521.

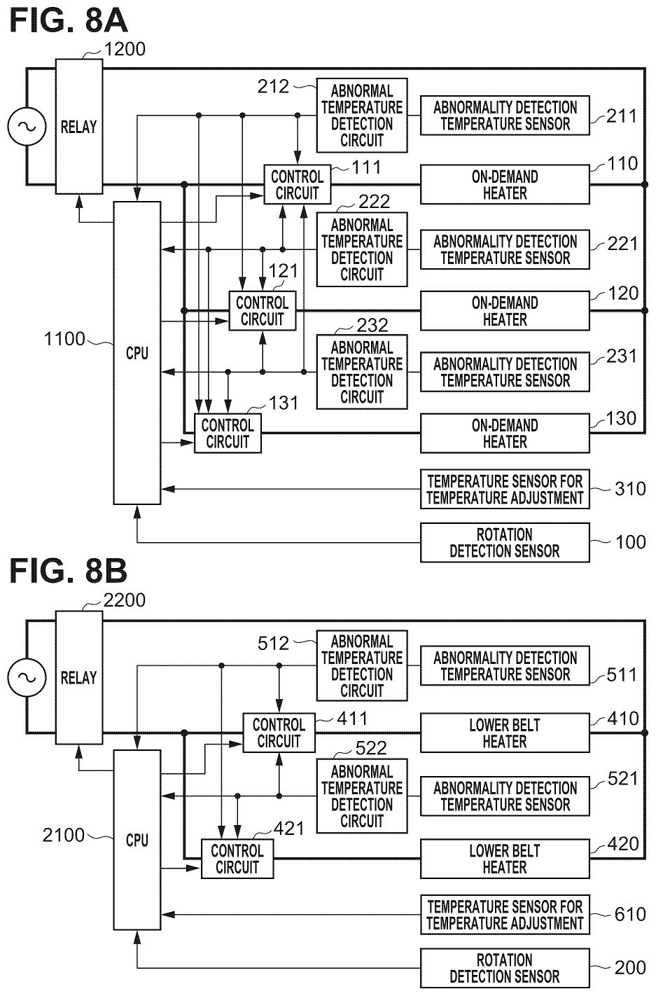

FIGS. 8A and 8B are control block diagrams each illustrating a fixing system according to the third exemplary embodiment. FIG. 8A is a control block diagram of the upper fixing belt system 10. The upper fixing belt system 10 includes the CPU 1100, the relay 1200, the control circuits 112, 122, and 132, and the on-demand heaters 110, 120, and 130. Furthermore, the upper fixing belt system 10 includes the temperature sensor for temperature adjustment 310, the abnormality detection temperature sensors 211, 221, and 231, abnormal temperature detection circuits 212, 222, and 232, and the rotation detection sensor 100.

The CPU 1100 controls the control circuits 112, 122, and 132 based on temperature information from the temperature sensor for temperature adjustment 310 to adjust power supplied to the on-demand heaters 110, 120, and 130 and thereby adjust a temperature. The abnormality detection temperature sensors 211, 221, and 231 monitor a heating state of the on-demand heaters 110, 120, and 130, and transmits temperature information to the abnormal temperature detection circuits 212, 222, and 232. The abnormal temperature detection circuits 212, 222, and 232 each compare a predetermined threshold and corresponding temperature information from the abnormality detection temperature sensors 211, 221, and 231. In a case where the temperature information exceeds the threshold, signals for forcibly stopping the control circuits 112, 122, and 132 are output to the control circuits 112, 122, and 132, and the CPU 1100. In this case, the control circuits 112, 122, and 132 are forcibly stopped operating, and power supply to the on-demand heaters 110, 120, and 130 is cut off. The signal for forced stop is latched, and the cut-off of power supply continues even if a temperature is decreased. The relay 1200 is connected in series with the line that supplies power to the on-demand heaters 110, 120, and 130. The relay 1200 performs power supply in an ON-state and stops power supply in an OFF-state. ON/OFF control is performed by the CPU 1100. The rotation detection sensor 100 monitors a rotation state of the first belt 11. In a case of detecting a stop, the rotation detection sensor 100 outputs a signal indicating a stop state to the CPU 1100. The CPU 1100, which has received the signal, turns OFF the relay 1200.

FIG. 8B is a control block diagram of the lower fixing belt system 20. The upper fixing belt system 10 includes the CPU 2100, the relay 2200, control circuits 411 and 421, and the lower belt heaters 410 and 420. Furthermore, the upper fixing belt system 10 includes the temperature sensor for temperature adjustment 610, the abnormality detection temperature sensors 511 and 521, the abnormal temperature detection circuits 512 and 522, and the rotation detection sensor 200.

The CPU 2100 controls the control circuits 412 and 422 based on temperature information from the temperature sensor for temperature adjustment 610 to adjust power supplied to the lower belt heaters 410 and 42, and thereby adjust a temperature.

The abnormality detection temperature sensors 511 and 521 monitor a heating state of the lower belt heaters 410 and 420, and transmits temperature information to the abnormal temperature detection circuits 512 and 522. The abnormal temperature detection circuits 512 and 522 each compare a predetermined threshold and corresponding temperature information from the abnormality detection temperature sensors 511 and 521. In a case where the temperature exceeds the threshold, the abnormal temperature detection circuits 512 and 522 output signals for forcibly stopping the control circuits 412 and 422 to the CPU 2100. In this case, the control circuits 412 and 422 are forcibly stopped operating, and power supply to the lower belt heaters 410 and 420 is cut off. The signal for forced stop is latched, and the cut-off of power supply continues even if a temperature is decreased. The relay 2200 is connected in series with the line that supplies power to the lower belt heaters 410 and 420. The relay 2200 performs power supply in an ON-state and stops power supply in an OFF-state. ON/OFF control is performed by the CPU 2100. The rotation detection sensor 200 monitors a rotation state of the second belt 21. In a case of detecting a stop, the rotation detection sensor 200 outputs a signal indicating a stop state to the CPU 2100. The CPU 2100, which has received the signal, turns OFF the relay 2200.

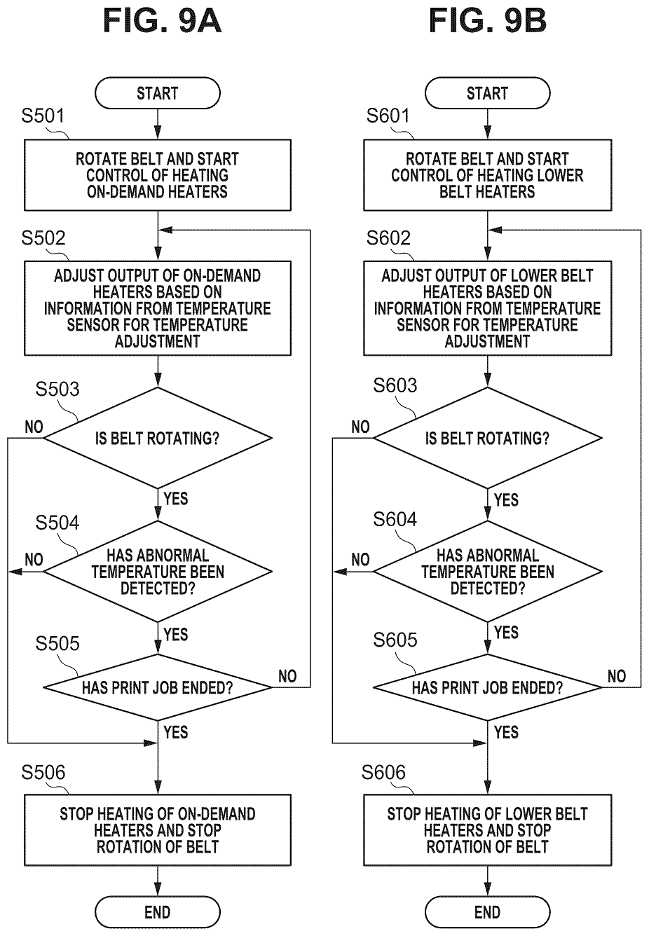

FIGS. 9A and 9B are flowcharts of controlling the fixing system according to the third exemplary embodiment. FIG. 9A is a flowchart describing control of the upper fixing belt system 10.

When control of the upper fixing belt system 10 is started, the processing proceeds to step S501.

In step S501, the CPU 1100 controls the driving roller 104 for the first belt 11 to rotate the first belt 11, and starts control of heating the on-demand heaters 110, 120, and 130. The processing then proceeds to step S502.

In step S502, the CPU 1100 adjusts output of the on-demand heaters 110, 120, and 130 based on temperature information from the temperature sensor for temperature adjustment 310 and adjusts a temperature of the first belt 11.

The temperature of the first belt 11 is adjusted to be a constant temperature to maintain quality of a printing medium. The processing proceeds to step S503.

In step S503, the CPU 1100 determines whether the first belt 11 is rotating based on a value from the rotation detection sensor 100. In a case where the CPU 1100 determines that the first belt 11 is rotating based on the value from the rotation detection sensor 100 (YES in step S503), the processing proceeds to step S504. In a case where the CPU 1100 determines that the first belt 11 is not rotating based on a signal from the rotation detection sensor 100 (NO in step S503), the processing proceeds to step S506.

In step S504, the CPU 1100 checks whether an abnormal temperature has been detected from input signals from the abnormal temperature detection circuits 212, 222, and 232. In a case where the abnormal temperature has not been detected (NO in step S504), the processing proceeds to step S505. In a case where the abnormal temperature has been detected (YES in step S504), the processing proceeds to step S506.

In step S505, the CPU 1100 determines whether it is notified of the end of the print job by the print job controller, which is not illustrated. In a case where the CPU 1100 is notified of the end of the print job (YES in step S505), the processing proceeds to step S506. In a case where the CPU 1100 is not notified of the end of the print job (NO in step S505), the processing proceeds to step S502.

In step S506, the CPU 1100 stops control of heating the on-demand heaters 110, 120, and 130 to stop the rotation of the first belt 11, and ends the control.

FIG. 9B is a flowchart describing control of the lower fixing belt system 20.

When control of the lower fixing belt system 20 is started, the processing proceeds to step S601.

In step S601, the CPU 2100 controls the driving roller 204 for the second belt 21 to rotate the second belt 21, and starts control of heating the lower belt heaters 410 and 420. The processing then proceeds to step S602.

In step S602, the CPU 2100 adjusts output of the lower belt heaters 410 and 420 based on temperature information from the temperature sensor for temperature adjustment 610 to adjust the temperature of the second belt 21. The temperature of the second belt 21 is controlled to be a constant temperature to maintain quality of a printing medium. The processing then proceeds to step S603.

In step S603, the CPU 2100 determines whether the second belt 21 is rotating based on a value from the rotation detection sensor 200. In a case where the CPU 2100 determines that the second belt 21 is rotating based on the value from the rotation detection sensor 200 (YES in step S603), the processing proceeds to step S604. In a case where the CPU 2100 determines that the second belt 21 is not rotating based on a signal from the rotation detection sensor 200 (NO in step S603), the processing proceeds to step S606.

In step S604, the CPU 2100 checks whether an abnormal temperature has been detected from input signals from the abnormal temperature detection circuits 512 and 522. In a case where the abnormal temperature has not been detected (NO in step S604), the processing proceeds to step S605. In a case where the abnormal temperature has been detected (YES in step S604), the processing proceeds to step S606.

In step S605, the CPU 2100 determines whether it is notified of the end of the print job by the print job controller, which is not illustrated. In a case where the CPU 2100 is notified of the end of the print job (YES in step S605), the processing proceeds to step S606. In a case where the CPU 2100 is not notified of the end of the print job (NO in step S605), the processing proceeds to step S602.

In step S606, the CPU 2100 stops control of heating the lower belt heaters 410 and 420 to stop the rotation of the second belt 21, and ends the control.

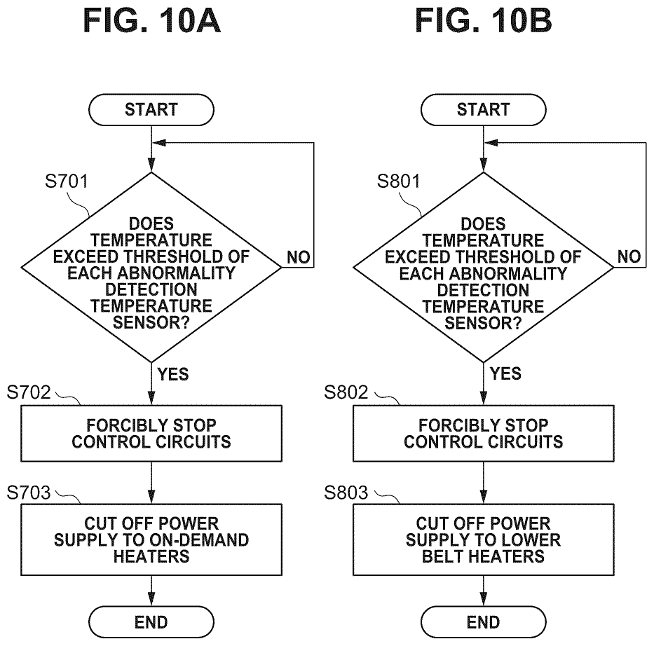

FIGS. 10A and 10B are flowcharts of the forced stop by the abnormal temperature detection circuits 212, 222, and 232 and the abnormal temperature detection circuits 512 and 522 in the fixing system according to the third exemplary embodiment. FIG. 10A is a flowchart describing control of forced stop by the abnormal temperature detection circuits 212, 222, and 232 in the upper fixing belt system 10. The forced stop by the abnormal temperature detection circuits 212, 222, and 232 is performed regardless of a sequence of the flowchart of the control described with reference to FIGS. 8A and 8B. When the abnormal temperature detection circuits 212, 222, and 232 start to operate, the processing proceeds to step S701.

In step S701, the abnormal temperature detection circuits 212, 222, and 232 compare respective temperature information input from the abnormality detection temperature sensors 211, 221, and 231 and a threshold. In a case where the temperature information exceeds the threshold (YES in step S701), the processing proceeds to step S702. In a case where the temperature information does not exceed the threshold (NO in step S701), the processing in step S701 is repeated.

In step S702, the abnormal temperature detection circuits 212, 222, and 232 forcibly stop all of the control circuits 112, 122, and 132. The processing then proceeds to step S703.

In step S703, all of the control circuits 112, 122, and 132 are stopped, and power supply to the on-demand heaters 110, 120, and 130 is cut off.

FIG. 10B is a flowchart of the forced stop by the abnormal temperature detection circuits 512 and 522 in the lower fixing belt system 20. When the abnormal temperature detection circuits 512 and 522 start to operate, the processing proceeds to step S801.

In step S801, the abnormal temperature detection circuits 512 and 522 compare respective temperature information input from the abnormality detection temperature sensors 511 and 521 and a threshold. In a case where the temperature information exceeds the threshold (YES in step S801), the processing proceeds to step S802. In a case where the temperature information does not exceed the threshold (NO in step S801), the processing in step S801 is repeated.

In step S802, the abnormal temperature detection circuits 512 and 522 forcibly stop all of the control circuits 412 and 422. The processing then proceeds to step S803.

In step S803, all of the control circuits 411 and 421 are stopped, power supply to the lower belt heaters 410 and 420 is cut off, and the processing ends.

The above-mentioned configuration enables detection of abnormal heating with high responsivity in the on-demand fixing system.

A fourth exemplary embodiment is directed to a fixing system in a case where the thermo switches 210, 220, and 230 are replaced with the abnormality detection temperature sensors 211, 221, and 231, and the thermo switches 510 and 520 are replaced with the abnormality detection temperature sensors 511 and 521.

Similarly to the thermo switches according to the second exemplary embodiment, the configuration enables detection of a temperature of the second belt 21 without raising concerns about abrasion on both of the second belt 21 and the abnormality detection temperature sensors 211, 221, and 231 due to friction between the second belt 21 and the abnormality detection temperature sensors 211, 221, and 231.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-111070, filed Jul. 5, 2023, which is hereby incorporated by reference herein in its entirety.

What is claimed is:

1. An ink-jet recording apparatus comprising:
a first belt configured to heat a sheet;
a heating unit disposed inside the first belt and configured to heat the first belt in a non-contact manner;
a second belt configured to come into contact with the first belt to form a nip portion together with the first belt, and configured to fix an ink image on the sheet to the sheet in the nip portion;
a pressing member configured to come into contact with an inner circumferential surface of the second belt in the nip portion, configured to press the first belt via the second belt, and including an opening formed in a heated region to be heated by the heating unit; and
a temperature detection member disposed in the opening and configured to detect a temperature of the inner circumferential surface of the second belt.

2. The ink-jet recording apparatus according to claim 1, wherein the pressing member is made of metal.

3. The ink-jet recording apparatus according to claim 2, wherein a surface of the pressing member is embossed and is configured to slide with the second belt.

4. The ink-jet recording apparatus according to claim 1, wherein the temperature detection member is located below a contact surface between the pressing member and the second belt.

5. The ink-jet recording apparatus according to claim 1, wherein a plurality of heating units is provided along a sheet conveyance direction.

6. The ink-jet recording apparatus according to claim 5, wherein a plurality of temperature detection members is provided and is disposed at respective positions corresponding to a plurality of heated regions of the plurality of heating units.

7. The ink-jet recording apparatus according to claim 1, wherein the pressing member is configured to press the second belt at least in the heated region.

8. The ink-jet recording apparatus according to claim 1, wherein a curving process is performed on one side of the opening and the one side of the opening is configured to slide with the second belt.

9. The ink-jet recording apparatus according to claim 1, wherein the temperature detection member is a contact-type temperature detection member, part of which protrudes from the opening, configured to detect a temperature of the second belt.

10. The ink-jet recording apparatus according to claim 1, wherein the heating unit includes a reflector that opens toward the heated region.

11. The ink-jet recording apparatus according to claim 10, wherein, in a sheet conveyance direction, the temperature detection member is disposed between an upstream end of the reflector and a downstream end of the reflector.
